(19) United States
(12) Patent Application Publication
(10) Pub. No.: US 2006/0067272 A1
(43) Pub. Date: Mar. 30, 2006

(54) Method and system for fast roaming of a mobile unit in a wireless network

(76) Inventors: Huayan Amy Wang, Hauppauge, NY (US); William Sakoda, East Setanket, NY (US)

Correspondence Address: Fay Kaplun & Marcin, LLP, 150 Broadway, Suite 702, New York, NY, 10038, US

(21) Appl. No.: 10/954,436

(22) Filed: Sep. 30, 2004

(51) Int. Cl. H04Q 7/00

(52) U.S. Cl. 370/331

(57) ABSTRACT

Described is a method and system for fast roaming of a mobile unit in a wireless network. An access point receives a packet from a wireless computing unit which includes unit identifying data and an association request to establish communications via the access point. The packet is processed to initiate an authentication procedure of the unit using the unit identifying data. The authentication procedure is performed by at least one of the access point and an authentication server connected to the access point. Wireless transmissions of further packets between the unit and the access point (e.g., the further packets being related to the authentication procedure) are prioritized. The authentication procedure is completed to determine if the association request of the unit be granted.

### BACKGROUND INFORMATION

In the few years since the Institute of Electrical and Electronics Engineers (“IEEE”) approved the 802.11 wireless local area network (“WLAN”) standard, the proliferation of wireless communication and computing products has been exceptional. To accommodate the ever-increasing demand for bandwidth from wireless devices, administrators of large networks typically situate wireless access points (“APs”, e.g., routers, switches, bridges, repeaters, blade, etc.) in strategic locations throughout the entire desired coverage area. Today, it is not unusual to find tens, hundreds, or even thousands of APs in airports, coffee houses, universities, or other businesses and institutions that aim to offer ubiquitous wireless network access.

As wireless computing products continue to decrease in size, the need has developed for uninterrupted network access while users in transit roam away from the operating range of one AP and into that of another. In conventional IEEE 802.11 WLANs that utilize the Wired Equivalent Privacy (“WEP”) security standard, the process of associating with a new AP may be quick and simple when it does not involve an authentication process with a server. However, there are a number of flaws with this process which causes some businesses to refrain from adopting full-fledged wireless networking solutions.

Recently, the security shortcomings of conventional WLANs were addressed with the ratification of the IEEE 802.11i standard. This new standard introduces many security features, including encryption and authentication enhancements, key management and establishment, and the use of authentication servers. As a result, the association and authentication process between an AP and a roaming MU greatly increases a total roam time. To improve the roam time, a pre-authentication procedure is incorporated into the new standard that routes authentication packets to other APs in the network prior to the MU coming within their range. However, even with pre-authentication, a minimum six-packet exchange (e.g., an association request, an association response plus a Robust Secure Network Information Element (“RSN IE”), and a 802.1X four-way handshake) must be performed each time an MU attempts to connect to a new AP. This exchange may take several milliseconds in a lightly loaded network, and substantially longer in a heavily loaded environment where both the AP and the MU must contend for the wireless medium. Such delays are unacceptable in the demanding wireless networking environments of today.

### SUMMARY OF THE INVENTION

The present invention relates a method and system for fast roaming of a mobile unit in a wireless network. An access point receives a packet from a wireless computing unit which includes unit identifying data and an association request to establish communications via the access point. The packet is processed to initiate an authentication procedure of the unit using the unit identifying data. The authentication procedure is performed by at least one of the access point and an authentication server connected to the access point. Wireless transmissions of further packets between the unit and the access point (e.g., the further packets being related to the authentication procedure) are prioritized. The authentication procedure is completed to determine if the association request of the unit be granted.

The present invention also includes a system which may include a wireless computing unit, an access point and an authentication server. The unit generates a packet which includes unit identifying data and an association request to establish wireless communications. The access point receives and processing the packet to initiate an authentication procedure of the unit using the unit identifying data. The authentication procedure is performed by at least one of the access point and the authentication server. Wireless transmissions of further packets between the unit and the access point are prioritized; the further packets are related to the authentication procedure. Upon a completion of the authentication procedure, a determination is made if the association request of the unit be granted.

### BRIEF DESCRIPTION OF THE DRAWINGS

FIG. 1 is an exemplary embodiment of a mobile network according to the present invention.

FIG. 2 is an exemplary embodiment of an authentication sequence according to the present invention.

FIG. 3 is an exemplary method for improving the roam time of MUs according to the present invention.

### DETAILED DESCRIPTION

The present invention may be further understood with reference to the following description and the appended drawings, wherein like elements are provided with the same reference numerals. The present invention provides a method to improve the roam time of MUs operating in a wireless network (e.g., using the IEEE 802.11i standard). By decreasing the amount of time an MU takes to associate with a new AP, a user in transit within the wireless coverage area may continue operating the MU with minimal interruption. Improved roam time is particularly important for applications that require low latency continuous connectivity (e.g., Voice Over Internet Protocol (“VoIP”) or streaming downloads).

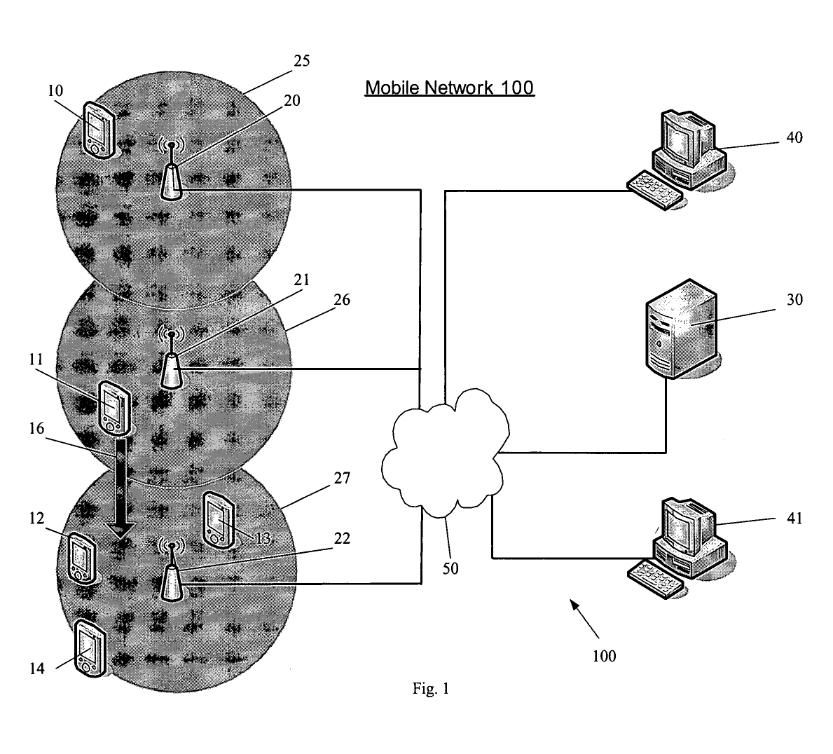

FIG. 1 shows an exemplary embodiment according to the present invention of a mobile network 100 that may, for example, operate within a WLAN in infrastructure mode. The mobile network 100 may include a plurality of MUs 10-14, a plurality of APs 20-22, an authentication server 30, a plurality of workstations 40-41 (e.g., computing devices) and a communications network 50. Those of skill in the art will understand that the exemplary embodiments of the present invention may be used with any mobile network and that the mobile network 100 is only exemplary.

In this exemplary embodiment and for the remainder of the discussion that follows, the IEEE 802.11i standard protocol is utilized. However, the methods and systems of the present invention for improving roam time in a wireless network may be employed in any WLAN with APs that undergo a security exchange with MUs prior to allowing network access.

The APs 20-22 may be, for example, routers, switches, bridges or blades that connect the wireless and wired networks. According to the IEEE 802.11i standard, the APs 20-22 serve as authenticators. The APs 20, 21, and 22 have coverage areas 25, 26, 27, respectively. In addition, the APs 20, 21, and 22 may support Robust Secure Network (“RSN”) with several data confidentiality protocols, including multicast and unicast cipher suites employing, for example, Counter-Mode/CBC-Mac Protocol (“CCMP”), Wireless Robust Authentication Protocol (“WRAP”), Temporal Key Integrity protocol (“TKIP”), WEP and 802.1X EAP.

The workstations 40-41 are connected to the wired portion of the mobile network 100 and may be located remotely from the APs 20-22. The workstations 40-41 may be, for example, desktop or laptop computers or any other computing device known to those of skill in the art. The authentication server 30 is a server computer that provides centralized remote user authentication and accounting for devices on the network, or Authentication, Authorization, Accounting (“AAA”) services. For example, the authentication server 30 may include, but is not limited to, a RADIUS server, a Diameter server, or a Kerberos server.

The MUs 10-14 may be any type of computer or processor based portable device (e.g., desktop or laptop computers, PDAs, mobile or cellular phones, two-way pagers, bar code scanners, etc.) capable of connecting to the mobile network 100 through a wireless communication arrangement (e.g., a wireless modem, transmitter, etc.). According to the IEEE 802.11i protocol, the MUs 10-14 may be also be referred to as supplicants. The MUs 10-14 may be designed only for a specific purposes (e.g., scanning bar codes, VoIP communications, text messaging, etc.), or may be handheld devices with different purposes, to which various functionalities have been added through the appropriate software modules. In one embodiment, the MUs 10-14 are based on a multi-purpose personal digital assistant (“PDA”) such as those running the Microsoft Pocket PC 2003 operating system, or similar.

Because the MUs 10-14 are portable, they are sufficiently small to be easily carried. The operators of each of the MUs 10-14 may be roaming within the coverage areas 25, 26, 27 of the mobile network 100. For example, in the exemplary embodiment of FIG. 1, the MU 11 is being moved along the path 16 toward coverage area 27 from its current location within coverage area 26. While the MU 11 is closest to the AP 21, it may be connected to the communications network 50 through the AP 21. As the MU 11 roams closer to the AP 22 along the path 16 and further from the AP 21, the MU 11 may need to disconnect from the AP 21 and instead connect to the AP 22 in order to maintain continued wireless communication. Before connecting to the AP 22, however, the MU 11 must authenticate with the AP 22 by performing a six-packet security exchange, to be described in greater detail below.

The foregoing embodiment of the mobile network 100 is not to be construed so as to limit the present invention in any way. As will be apparent to those skilled in the art, different types of MUs may be used to communicate over the same data network, as long as they work under compatible protocols. Other configurations with different numbers of MUs, APs, workstations, and/or servers may also be used to implement the method of the present invention.

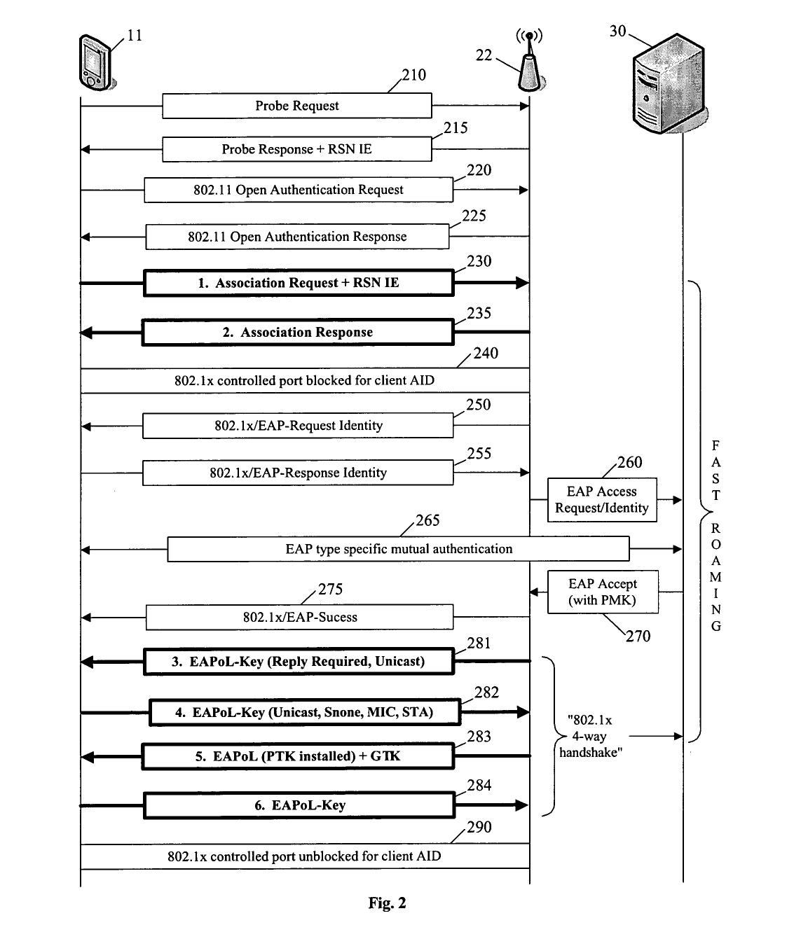

FIG. 2 shows an exemplary embodiment of an authentication sequence according to the present invention. In order to facilitate the description, the previously discussed example of the MU 11 roaming away from the AP 21 toward the AP 22 will be used. For example, when the MU 11 is active, it may search (e.g., continually or every predetermined time period) for an optimal AP to associate with by sending probe request frames 210. All APs within the transmission range of the MU 11 respond by sending a probe response 215 that includes an RSN IE. As described in the IEEE 802.11i specification, the RSN IE may include authentication and Pairwise cipher suite selectors, a single group cipher suite selector, an RSN capabilities field, the PMKID count and PMKID List.

After gathering the probe response and RSN IE from each responding AP, the MU 11 weighs several factors including the supported data rates, the AP load, and security characteristics to determine which AP to associate with. Upon making that determination, the MU 11 and the target AP undergo the standard 802.11 Open Authentication sequence. In the exemplary mobile network 100, the MU 11 may make the determination to associate with the AP 22 as it moves along the path 16 away from the AP 21. The Open Authentication sequence includes the MU 11 first sending an Open Authentication request 220 to the AP 22 and the AP 22 subsequently sending an Open Authentication response 225.

After the Open Authentication sequence, the MU 11 sends an association request 230 to the AP 22 that also contains an RSN IE (e.g., requesting TKIP and 802.1X EAP authentication). With this information, the association is either allowed or denied. The association request 230 and the association response 235 comprise two packets of the six-packet exchange that is performed when an MU roams to a new AP.

If association is successful, a common security policy is established and the MU 11 may begin communication with the AP 22. However, data traffic is filtered so that only 802.1X Extensible Authentication Protocol (“EAP”) frames may pass at this point. All other traffic (e.g., HTTP, DHCP, and POP3 packets, etc.) is impeded by the AP 22. The association is temporarily mapped to the 802.1X port, which is blocked 240 until the 802.1X authentication procedure is complete.

The 802.1X authentication procedure begins with the AP 22 (e.g., the authenticator) submitting to the MU 11 an identity request 250 (e.g., the unauthenticated supplicant). The MU 11 replies by sending a response identity message 255. The AP 22 next forwards this information in an EAP access request/identity message 260 to the authentication server 30. Depending on the EAP type utilized by the authentication server 30 (e.g., token cards, one-time passwords, digital certificates, etc.), a specific mutual authentication algorithm is performed 265. This may involve the authentication server 30 issuing an identity challenge that is passed through the AP 22 to the MU 11. The MU 11 in response issues a response identity. If the supplicant's identity is accepted, the authentication server 30 issues an EAP accept message 270 to the AP 22. Next, the AP 22 dispatches a message 275 to the MU 11 indicating successful authentication with the authentication server 30.

At this point, although the MU 11 is authenticated by the authentication server 30, the 802.1X authentication process is not yet complete. In order to ensure that the communication between the AP 22 and the MU 11 is live and not being replayed, the AP 22 and the MU 11 next mutually authenticate. This is accomplished by first embedding into the accept message 270 a Pairwise Master Key (“PMK”). The PMK is a master value that is passed to all APs upon successful authentication with a new MU. The PMK is combined with the AP address, the MU address, a pseudo-random value generated by the AP (e.g., an Anonce), and a pseduo-random value generated by the MU (e.g., an Snonce) to create a dynamic Pairwise Transient Key (“PTK”). Because the PTK is derived from two psuedo-random variables, a fresh PTK is generated each time an AP associates with a new MU.

The process of deriving a PTK and implementing mutual authentication between an AP and an MU is commonly referred to as an 802.1X four-way handshake. The first and second handshake messages 281 and 282 combine the above mentioned values to derive a PTK. That PTK is installed in the third handshake 283. A Group Temporal Key (“GTK”) is also provided in the third handshake message to protect multicast traffic. The fourth handshake 284 message indicates that the temporal keys are now in place and may be used by the data confidentiality protocols. The 802.1X four-way handshake comprises the remaining four packets of the six-packet exchange that must be performed when an MU roams to a new AP.

If the 802.1X four-way handshake is successful, the 802.1X authentication process under the 802.11i standard is complete. At this point, the 802.1X port is unblocked 290 and the MU 11 is free to exchange all data packet types with the AP 22. Thus, the MU 11 is granted a full access to the resources in the mobile network 100.

The foregoing authentication sequence is typically performed when an MU first associates with any AP in a WLAN operating according to the IEEE 802.11i protocol. As previously discussed, the IEEE 802.11i protocol also features pre-authentication for faster roaming across APs in a wireless network. By having a pre-authentication packet routed through the AP that it is currently associated with, a roaming MU is able to become partially authenticated to a remote AP before actually moving to it. Nevertheless, a six-packet exchange comprised of the association request plus RSN IE 230 along with the PMKID, the association response 235, and the 802.1X four-way handshake 281-284 must be completed each time the roaming MU attempts to associate with another AP. Under favorable lightly loaded network conditions, this six-packet exchange may take several milliseconds. However, in a more heavily loaded network where numerous devices are competing for the same wireless medium, the time required for this exchange to complete may be substantially longer, resulting in unacceptable delays for short-lived or time-sensitive applications (e.g., VoIP or streaming video).

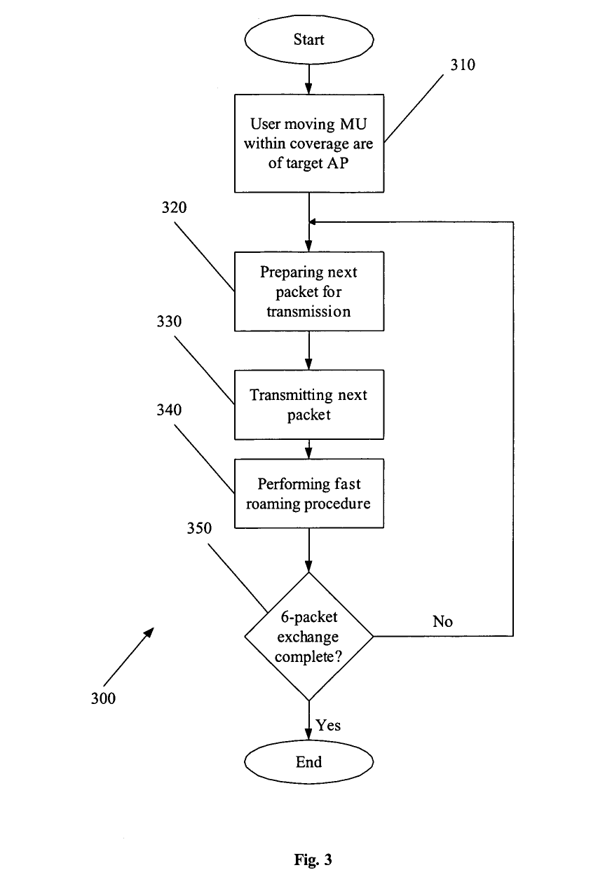

FIG. 3 shows an exemplary method 300 for improving the roam time of MUs in a WLAN employing the IEEE 802.11i protocol. In step 310, an MU roams into the coverage area of an AP with which it attempts to associate. In the example of FIG. 1, this may occur as the MU 11 moves along the path 16 into the coverage area 27 of the AP 22 and away from the coverage area 26 of the AP 21.

In step 320, the MU 11 prepares the next packet of the six-packet exchange for transmission. If the exchange has yet to begin, the next packet to be prepared is the packet (e.g., the association request plus RSN IE 230). Preparation may include, for example, the MU 11 attaching a high priority level packet identifier to each of the exchange packets so that other packets with lower level packet priority identifier (e.g., for standard wireless transmissions) must defer to the higher priority traffic.

In step 330, the packet that was prepared in the previous step is transmitted from the MU 11 to the target AP 22. The packet is received by the AP 22.

In step 340, a fast roaming procedure is performed using the identifying data contained in the packet. Depending on the specific application of the present invention, the fast roaming procedure may include many different actions to authenticate the MU 11. For instance, returning to the example of improving roam time by attaching high priority lever packet identifier to the six-packet exchange, the fast roaming procedure may include the AP 22 delaying the processing of lower priority traffic (e.g., for standard wireless transmissions) until the higher priority packets are processed. For example, a portion of lower priority transmissions between an MU and the AP 22 may be impeded to allow completion of higher priority transmissions between another MU and the AP 22. This does not mean, however, that the packets of the six-packet exchange necessarily preempts all other traffic, as they may still need contend with equally high or higher priority traffic.

In step 350, a determination is made as to whether the six-packet exchange is complete. If it is complete, the fast roaming method 300 of the present invention ends and all the components of the WLAN may return to normal operation. For example, the MU 11 is permitted to establish wireless communications via the AP 22. Otherwise, if the exchange is not complete, the method 300 returns to the step 320 for preparation of the next packet, and the subsequent steps are repeated until the fast roaming method 300 ends and the roaming MU 11 is authenticated with the AP 22.

Although the foregoing fast roaming method 300 of the present invention is described with reference to sending the packets of the six-packet exchange with a high priority, the method 300 may include other applications of the present invention. For example, a co-operative client policy may be implemented where MUs already connected to the target AP will refrain from transmission if they detect the presence of any packet of the six-packet exchange. Referring back to the exemplary embodiment of FIG. 2, as the MUs 12-14 communicate with the AP 22, they may be configured to periodically listen for the association messages 230, 235 or the Extensible Authentication Protocol over LAN (“EAPoL”) messages of the 802.1X four-way handshake 281-284. Thus, upon the MU 11 attempting to associate with the AP 22 (step 310), the packet is prepared (step 320), the transmission (step 330) of which causes the MUs 12-14 to temporarily halt communications (step 350) with the AP 22 until the exchange is complete (step 350).

Moreover, the co-operative policy may be flexible so that not all traffic must yield to the packets of the six-packet exchange. For example, only lower priority traffic or larger messages may be configured to pause transmission upon detecting the presence of the packets.

Another application of the method 300 of the present invention is for the target AP 22 to allocate a Transmission Opportunity (“TXOP”) to the MU 11 during the transmission of the second or the third packet of the six-packet exchange. A TXOP is a reservation of a time slice on the air dedicated specifically for predefined traffic. Establishing a TXOP during the transmission of the second or third packet ensures that the 802.1X four-way handshake 281-284 has sufficient time to complete without having to compete for a time slice on the air with the other traffic in the WLAN.

It should be noted that the 802.1X four-way handshake 281-284 may require a greater processing time by both the MU 11 and the AP 22 than other conventional traffic. This is because both the MU 11 and the AP 11 must perform calculations on the PMK provided by the authentication server 30 derive and install the appropriate temporal keys (e.g., a PTK and GTK). As a result, the TXOP may be idle while the calculations are being made. The idle airtime may result in MUs that are unaware that the 802.1X four-way handshake 281-284 is taking place (e.g., MUs returning from a power-saving state) attempting to transmit on the allocated time slices on the air. To prevent this, the fast roaming procedure (step 340) may include the AP 22 and/or the MU 11 transmitting null packets as they perform their calculations so that other MUs may not gain access to the TXOP time slice.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising the steps of:
receiving by an access point a packet from a wireless computing unit, the packet including unit identifying data and an association request to establish communications via the access point;
processing the packet to initiate an authentication procedure of the unit using the unit identifying data, wherein the authentication procedure is performed by at least one of the access point and an authentication server connected to the access point;
prioritizing wireless transmissions of further packets between the unit and the access point, the further packets being related to the authentication procedure; and
completing the authentication procedure to determine if the association request of the unit be granted.

2. The method according to claim 1, wherein the access point includes at least one of a wireless switch, a wireless bridge, a wireless router and a wireless blade.

3. The method according to claim 1, wherein the unit is one of a laptop computer, a PDA, a mobile phone, a two-way pager and a bar code scanner.

4. The method according to claim 1, further comprising the step of:
if the association request is granted, allowing the unit to establish the wireless communications via the access point.

5. The method according to claim 1, wherein the prioritizing step includes a substep of:
impeding at least a portion of further wireless transmissions between at least one further wireless unit and the access point until the wireless transmissions of the further packets between the unit and the access point are completed.

6. The method according to claim 1, wherein the packet includes a first level packet priority identifier prioritizing the wireless transmission of the packet, the first level packet priority identifier being a higher priority than a second level packet priority identifier for packets of standard wireless transmissions.

7. The method according to claim 1, wherein the prioritizing the step includes a substep of:
assigning to the further packets a first level packet priority identifier prioritizing the wireless transmission of the further packets, the first level packet priority identifier being a higher priority than a second level packet priority identifier for packets of standard wireless transmissions.

8. The method according to claim 1, wherein the prioritizing the step includes a substep of:
reserving a time slice on air to be utilized exclusively for the wireless transmissions of the packet and the further packets.

9. A system, comprising:
a wireless computing unit generating a packet which includes unit identifying data and an association request to establish wireless communications;
an access point receiving and processing the packet to initiate an authentication procedure of the unit using the unit identifying data; and
an authentication server connected to the access point,
wherein the authentication procedure is performed by at least one of the access point and the authentication server,
wherein wireless transmissions of further packets between the unit and the access point are prioritized, the further packets being related to the authentication procedure and
wherein upon a completion of the authentication procedure, a determination is made if the association request of the unit be granted.

10. The system according to claim 9, wherein the access point includes at least one of a wireless switch, a wireless bridge, a wireless router and a wireless blade.

11. The system according to claim 9, wherein the unit is one of a laptop computer, a PDA, a mobile phone, a two-way pager and a bar code scanner.

12. The system according to claim 9, wherein if the association request is granted, the unit is allowed to establish the wireless communications via the access point.

13. The system according to claim 9, wherein at least a portion of further wireless transmissions between at least one further wireless unit and the access point is impeded until the wireless transmissions of the further packets between the unit and the access point are completed.

14. The system according to claim 9, wherein the packet includes a first level packet priority identifier prioritizing the wireless transmission of the packet, the first level packet priority identifier being a higher priority than a second level packet priority identifier for packets of standard wireless transmissions.

15. The system according to claim 9, wherein the further packets are assigned a first level packet priority identifier prioritizing the wireless transmission of the further packet, the first level packet priority identifier being a higher priority than a second level packet priority identifier for packets of standard wireless transmissions.

16. The system according to claim 9, wherein a time slice on air to be utilized exclusively for the wireless transmissions of the packet and the further packets is reserved.

17. An access point, comprising:
a wireless transmitter receiving from a wireless computing until a packet which includes unit identifying data and an association request to establish wireless communications via the access point; and
a processor processing the packet to initiate an authentication procedure of the unit, the processor performing the authentication procedure using the unit identifying data,
wherein wireless transmissions of further packets between the unit and the access point are prioritized, the further packets being related to the authentication procedure and
wherein upon the completion of the authentication procedure, the processor determines if the association request of the unit be granted.

18. The access point according to claim 17, wherein the access point is one of a wireless switch, a wireless bridge, a wireless router and a wireless blade.
